(19) United States
(12) Patent Application Publication
(10) Pub. No.: US 2006/0108519 A1
(43) Pub. Date: May 25, 2006

(54) Enhanced flat-panel display photosensing apparatus and method thereof

(75) Inventors: Shen-Hong Chou, Toufen Township (TW); Hui-Kai Chou, Taipei City (TW)

Correspondence Address: ARENT FOX PLLC, 1050 CONNECTICUT AVENUE, N.W., SUITE 400, WASHINGTON, DC, 20036, US

(73) Assignee: AU Optronics Corporation

(21) Appl. No.: 10/995,435

(22) Filed: Nov. 24, 2004

(51) Int. Cl. H01J 40/14

(52) U.S. Cl. 250/239

(57) ABSTRACT

A display photosensing apparatus and/or system for precision sensing of emitted light including a reflector unit configured to have at least one first hole, and a first photosensitive element disposed behind the reflector unit for receiving a light passing through the at least one first hole, can increase the sensitivity and control of the light detected and emitted from a light guide source.

### BACKGROUND OF THE INVENTION

1. Field of the Invention

The present invention relates to flat-panel display technology and associated photosensitive units employed therein to control color and light emission characteristic of the images displayed.

2. Related Art

Flat-panel displays have become very popular in the consumer and business electronics industry. Flat-panel displays are generally provided in electronic products, such as notebook computers, desktop monitors, televisions, digital cameras, DVD players, PDAs, mobile phones, portable gains, and car navigation systems, among other applications. Therefore, the ubiquitous application of flat-panel technology has led to ever-increasing needs for enhanced color sensing and control of light emitted from the associated light sources.

In a conventional flat-panel display 11, there is a light source 12 disposed typically at the bottom of the display 11, as can be seen in FIG. 1 (Prior Art). In FIG. 1, a cross-section of a conventional flat-panel display 11 is illustrated. At the top of the display 11 is a photo sensor 13. Disposed between the light source 12, at the bottom of the flat-panel display 11, is a light guiding plate 14 coupled to a reflector (not-shown, but disposed behind the light guiding plate). The light source 12 comprises a plurality of red, green, and blue light LED(s) emitting red, green, and blue light respectively into the flat-panel display.

In addition, a conventional color controller 15 and color drivers 16a-c are coupled to the conventional color sensors 13, which are disposed at the top-side of the light guide plate 14. The output from the color sensors 13 are processed by the color controller 15, which in turn directs the red 16a, green 16b and blue 16c color drivers to output proper driving signals to the red, green, and blue light LEDs respectively to produce the desired balanced white light emission from the light source 12. The light intensity of the green, blue, red light LED may be decay in different level, so the above color sensor feedback mechanism is adopted to control the quality of white light emitted from the light source 12.

More specifically, a light color sensor 13 disposed on the opposite side of the light source 12, wherein the sensor 13 picks up the color intensity and/or contrast data, which in turn is sent to the color controller 15. Accordingly, the color controller 15 sends a signal to a specified color driver 16a-16c. The color drivers 16a-16c are typically for the color ranges of red, green, or blue. The color driver modifies and/or adjusts the color and intensity according to the detected sensor 13 output.

The use of image-arrayed photosensors/detectors has a relatively long history in the solid-state unit industry, i.e. flat-panel display technology. These high sensitivity image arrays and maticied-based photo diode units have been often employed.

However, the prior art construction and placement of the photosensors 13 only senses that light which traverses the entire length of the light guiding unit 14. Thus, intensity and/or color variations over the entire spatial range of the light guiding unit 14 cannot be effectively detected for input into the color controller 15 for driving precise color variations.

Therefore, there is a present need for improved photosensitive units and methods for improved intensity/contrast sensing and control for flat-panel display units. Accordingly, the present invention provides a unit and method of improving flat-panel image color control.

### SUMMARY OF THE INVENTION

The present invention is devised in view of the problems of prior art, and its purpose is to provide for more effective flat-panel light generating and photosensitive element configurations and methods.

It is an object of the present invention to provide a more color representative flat-panel display image and the means to more effectively detect light intensity variations. More specifically, it is an object of the invention to provide a photosensitive element apparatus, unit, system and method, which is more representative of the specific color/contrast of the displayed flat-panel image, based upon the spatial location of the photosensitive elements.

It is an object of the present invention to provide an apparatus, which provides greater sensitivity to light emitted from a flat-panel display light guiding unit, compared to the prior art. The apparatus is configured such that at leased one hole structure is disposed within the reflector. The apparatus' photosensitive elements are disposed behind the light guiding unit, such that the light emitting from the light guiding unit exits through at least one hole structure incident onto at least one photosensitive element. The apparatus's photosensitive elements are positioned at one or a plurality of positions, wherein the photosensitive elements are located in at least one plane parallel with that of the light guiding unit.

It is another object of the present invention to provide a system for increasing the sensitivity of light emitted from a flat-panel display light guiding plate, wherein at least one photosensitive means is located behind the light guiding means and a reflector means. Furthermore, the photosensitive means is disposed within a parallel plane of the light guiding means, as opposed to being with in the same plane, as in the prior art. The system includes photosensitive detecting means, at least one light exiting means, a reflector means, a light guiding means, a light source means, at least one color driving means, and a color controlling means.

It is yet another object of the present invention to provide a method of increasing the sensitivity of detected light emitted from a flat-panel display light guiding unit by placing at least one photosensitive unit behind the light guiding unit and a reflector, wherein the photosensitive element unit is also placed in a parallel plane to that of the light guiding plate. The method further having at leased one hole structure in the reflector, such that the light emitted from the light guiding unit is detected after exiting through the one hole structure. Moreover, the method includes placing at least one light source unit at the periphery of the light guiding unit. The method further involves detecting the light from the light guide unit, controlling the color of drivers and light emission units.

To attain the purpose described above, the present invention provides a positioning of photosensitive elements to optimize color/contrast sensitivity for flat-panel displays.

A major disadvantage of prior art photosensing techniques lies in their inability to precisely measure the light intensity over the complete spatial range/area of the light guiding plate.

These and other objects in advantages of this invention will become apparent when considered in light of the following description and claims when taken together with the accompanying drawings.

### BRIEF DESCRIPTION OF THE DRAWINGS

The accompanying drawings, which are included to provide further the understanding of the present invention and are incorporated in and constitute a part of the specification, illustrating samples of the present invention and together with the description serve to explain the principles of the present invention.

The invention will now be described further with reference to the accompanying drawings in which:

FIG. 1 illustrates a conventional back light module according to the PRIOR ART.

FIG. 2 illustrates a cross-sectional view of a light generating and photosensitive apparatus according to an embodiment of the present invention.

FIG. 3 illustrates an expanded cross-sectional partial view of a photosensitive apparatus according to an embodiment of the present invention.

FIGS. 4A-4D illustrate various spatial configurations of light sources relative to photosensitive units according to alternate embodiments of the present invention.

FIG. 5 illustrates a top-view of a light generating and photosensitive apparatus according to an embodiment of the present invention.

FIG. 6 illustrates a view of a light generating and photosensitive apparatus coupled to control units according to an embodiment of the present invention.

FIG. 7 illustrates an expanded cross-sectional partial view of a light generating and photosensitive apparatus having a plurality of sensors for each of hole structures according to an alternate embodiment of the present invention.

FIGS. 8A-G illustrate cross-sectional views of hole structures according to various alternate embodiments of the present invention.

### DETAILED DESCRIPTION OF THE PREFERRED EMBODIMENTS

The following section describes an embodiment of the present invention based on drawings while exemplifying the light generating and photosensitive assembly, system and method of the present invention.

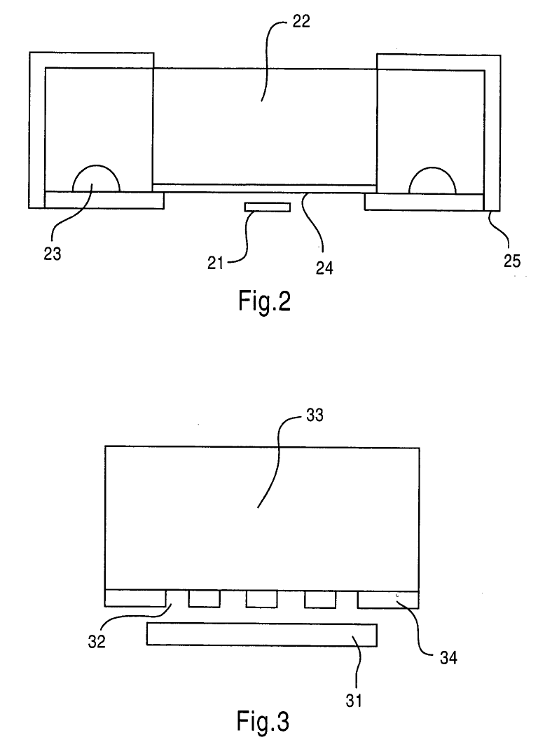

In the present invention, photosensitive elements 21, e.g., photo sensors, photo diodes, color sensors, etc., are located behind a light guiding unit 22 and further disposed away from the light generating/emitting source 23, e.g., a plurality of LEDs, as can be seen FIG. 2. According to the present invention, the photosensitive elements 21 are positioned behind the light guiding unit 22 so that they lie in a planar space distinct from the light guiding unit 22.

It should be noted that the light generating source(s) 23 of the present invention can be a plurality of different colored LEDs, or other light sources that are conventionally known. A specific number of the light generating source(s) 23 emit red light, another specific number of the light generating source(s) 23 emit green light, and further another specific number of the light generating source(s) 23 emit blue light.

A backlight unit of the display of the present invention is illustrated in the cross-sectional view of FIG. 2. There is a light guiding plate 22 with a reflector 24 coupled to it, along with light source holder 25 disposed on opposite sides. In contradistinction to the prior art, the present invention has photosensitive elements 21, e.g., photo sensors, located behind the light guiding plate 22 and the reflector 24. As mentioned above, the light generating sources 23, e.g., red, green, and blue light LEDs, in this embodiment, are sequentially disposed on the opposite sides of the light guiding plate 22. The red, green, and blue lights emitted by the light generating sources 23 are mixed to form a white light. If the red, green, and blue light sources have different intensities, the uniformity of the mixed white light could be poor. The uniformity of the mixed white light can be detected by the photosensitive elements 21.

A plurality of LEDs 23 emitting light into the display's light guiding plate 22 are utilized in an embodiment of the invention. In the illustrated embodiment, a light source 23 is incorporated into the assembly.

It should be noted that the reflector 24 can be any highly reflective conventional or innovative material, such as a polymeric, metallic or composite material. An example of a metallic material would be aluminum or steel. As a general matter, the material needs to be reflective of light.

It is understood the photosensitive elements 21 of the present invention include photosensors, photo diodes, photodetectors, color sensors, color controllers, etc. Such photosensitive units may be organic or inorganic in constituency. The photosensitive units discussed hereinabove and below have been described in a generic manner, since it is intended that any suitable light sensitive sensors, known or unknown, may be incorporated as a part of the sensor assembly according to the present invention. Therefore the list of sensor types is provided to illustrate various known sensors that are well suited for incorporation into a sensor assembly according to the present invention. It is to be understood that this non-exhaustive list of sensor types is provided for illustrative purposes only, and it is not intended to limit the type of sensor that may be employed in conjunction with the present invention disclosed herein.

It can be seen that photosensitive elements 31 are placed in close spatial relationship to hole structures 32 in the embodiment of the present invention illustrated in FIG. 3. The photosensitive elements 31 are disposed in such a manner as to permit the incident light exiting from a light guiding plate 33 through multiple hole structures 32a, 32b, 32c, 32d onto the light exiting the light guiding plate 33 and passing through a reflector 34 to become incident onto the photosensitive elements 31. The photosensitive elements 31 disposed behind the reflector 34 can simultaneously receive the light passing through the hole structures 32a˜32d. Accordingly, the reflector 34 has at least one hole structure 32, e.g., light exiting means, disposed there within. Thus, the photosensitive elements 31 are in close proximity to the hole structures 32. In fact, the photosensitive elements 31 are coupled to the light guiding plate 33 and the reflector 34.

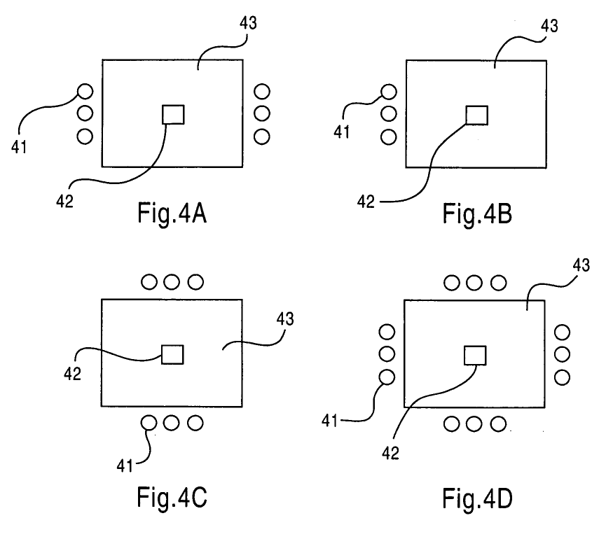

In FIG. 4A, light source means, e.g., LEDs 41 are disposed on either side of a reflector (not shown) and a light guiding plate 43, and at least one photosensitive element 42 is disposed somewhere between the oppositely disposed LEDs 41. As stated earlier, the photosensitive elements 42 can take various conventional forms, such as a photo diode, color sensor, color controller, or other forms not yet known. Accordingly, at least one photosensitive element 42 is positioned on a backside of the light guiding plate 43 and the reflector coupled thereto at a single and/or plurality of locations. The photosensitive element 42 is coupled to the light guiding plate 43 and the reflector.

FIG. 4B illustrates that the light emitting sources, e.g., LEDs, 41 can be disposed at a single location or side of the light guiding unit 43. In this embodiment, the LEDs 41 are located along a single side of the light guiding unit 43. In FIG. 4C, the light emitting sources 41 are disposed on a top and bottom periphery of the light guiding unit 43. In FIG. 4D, the light emitting sources 41 are disposed at various locations along the entire periphery of the light guiding unit 43.

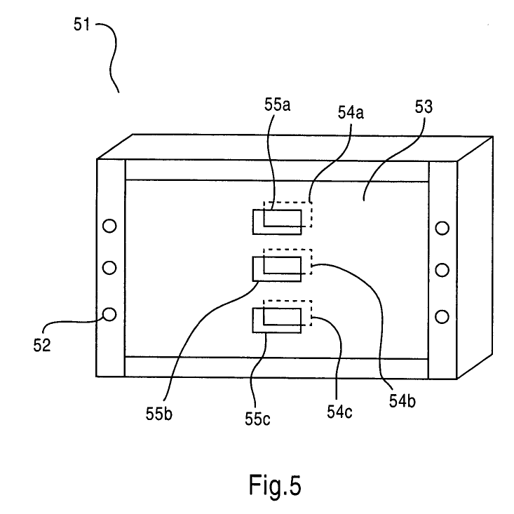

FIG. 5 illustrates an embodiment of a light generating and photosensitive display apparatus of the present invention. In particular, FIG. 5 shows a section of a display apparatus 51 having left and right light emitting sources e.g., LEDs, 52 respectively disposed along left and right sides of a light guiding unit 53 and three photosensitive elements 54a˜54c disposed behind three hole structures 55a˜55c. The three hole structures 55a˜55c are disposed along a vertical center line of the light guiding unit 53 and/or a reflector coupled thereto (not shown). The vertical center line substantially extends in the middle of the light guiding unit 53.

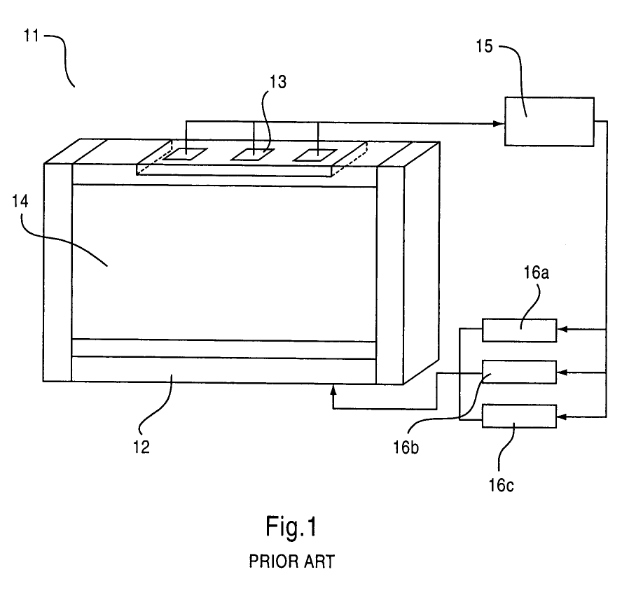

A principal advantage of this embodiment of the present invention over the prior art lies in the positioning of the photosensitive elements 54 at multiple locations behind at least a single plane parallel to the light guiding unit 53. Consequently, the light emitted from various locations of a face of the light guiding unit 53 is detected. This is a great improvement over the prior art of FIG. 1, in which only light that has propagated and been emitted along the length of the light guiding unit 14 is detected. The locations of the photosensitive elements 54 can be customized, tailored, and optimized to provide precision color/contrast data about the displayed flat-panel image.

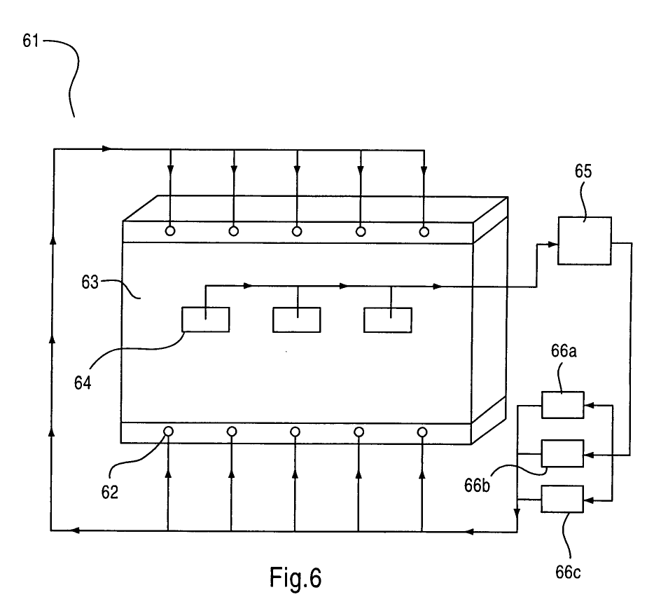

In FIG. 6, an alternate embodiment of the present invention employed in a display is illustrated, wherein light emitting sources (LEDs) 62 are disposed along opposite side peripheries of a light guiding unit 63 and photosensitive elements 64 are disposed to be equidistant along the back of the light guiding unit 63. As in FIG. 1, a color controller 65 and several color drivers 66a, 66b, 66c are utilized in the embodiment illustrated in FIG. 6. Output from the photosensitive elements 64 is processed by the color controller 65 and fedback to the red 66a, green 66b, blue 66c color drivers to alter and modify the color output of the light emitting units 62. Accordingly, the locations of the photosensitive elements 64 are selected in order to optimize the amount and sensitivity the photosensitive data inputted into the color controller 65, thereby maximizing the ultimate light emitting characteristics of the flat-panel display 61 imaging.

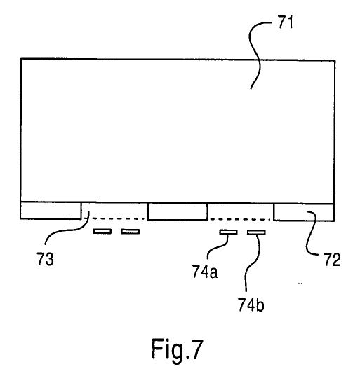

FIG. 7 illustrates an alternate embodiment of a light generating and photosensitive apparatus of the present invention. In FIG. 7, a light guiding unit 71 is coupled to a reflector 72, and at least one hole structure 73 is provided for at least one photosensitive element. However, depending on the size of the hole structures 73, more than one photosensitive element 74a and 74b may be used, as shown in FIG. 7. In this embodiment, several photosensitive elements 74a, 74b are used for each hole structure 73. The number and positioning of the photosensitive elements is predetermined based on the optimal level light/intensity sensitivity required for the LCD application.

The size of the individual hole structures may vary in circumference, diameter, and/or aspect ratio. More specifically, the hole structures can range from 0.1 mm to 10.0 mm across or along a widest point, such as the diameter in the case of a circular hole. In the preferred embodiment, the diameter of the hole is at least 1.0 mm.

It should also be noted that the hole structures may further comprise optically transparent and/or translucent materials, which permit various wavelengths of radiant energy to pass therethrough. Thus, in an alternate embodiment, the hole structures have a material filled into them, which is optically dissimilar to the reflector material.

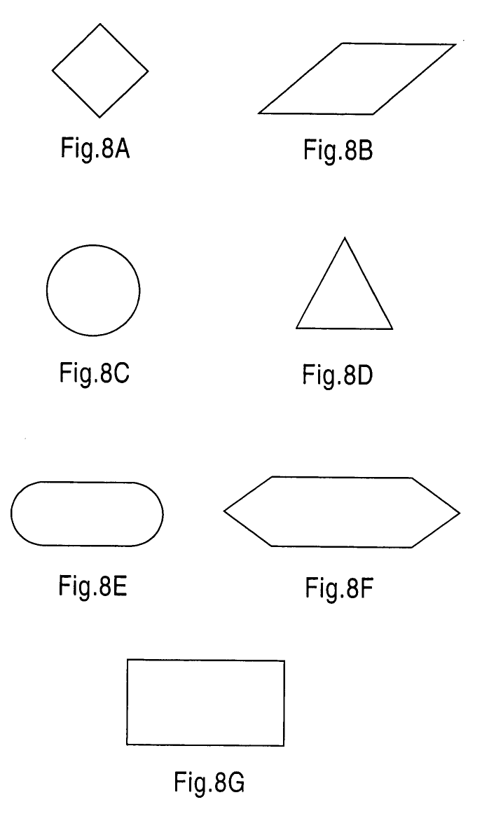

FIGS. 8A-8G illustrate various shapes that cross sections of the hole structures of the present invention may take. As illustrated in FIGS. 8A-8G, possible cross-sectional shapes of the hole structures include diamond (FIG. 8A), trapezoidal (FIG. 8B), circular (FIG. 8C), triangular (FIG. 8D), oval (FIG. 8E), composite diamond/rectangular (FIG. 8F), rectangular (FIG. 8G), etc. It should be noted that the shapes of FIGS. 8A-8G do not comprise a complete least of the possible shapes the hole structures may take. For example, in alternate embodiments, the hole structures are composites or hybrids of various cross-sectional shapes, wherein the shapes are optimized for photosensor operational sensitivity.

In the flat-panel display light generating and photosensitive apparatus and method of an embodiment of the present invention, the photosensitive elements, such as photosensors and photo diodes, are positioned behind the light guide plate or unit and coupled reflector. Further, the photosensitive elements are located within a parallel plane in close proximity and relationship to the light guide unit. The photosensitive elements are located at one or more of a plurality of spatial positions within a plane parallel to that of the light guide unit. Thus, the sensitivity and control of the light detected and emitted from a light guide source in the display is greatly improved.

Those skilled in the art will recognize that the unit and methods of the present invention have many applications, and that the present invention is not limited to the representative examples disclosed herein. Although illustrative, the embodiments disclosed herein have a wide range of modification, change and substitutions that are intended and in some instances some features of the present invention may be employed without a corresponding use of the other features.

Moreover, the scope of the present invention covers conventionally known variations and modifications to the apparatus and system components described herein, as would be known by those skilled in the art. Accordingly, it is appropriate that the appended claims be construed broadly and in a manner consistent with the scope of the invention.

What is claimed is:

1. A display photosensing apparatus for precision sensing of emitted light, comprising:
a reflector unit configured to have at least one first hole; and
a first photosensitive element disposed behind said reflector for receiving a light passing through said at least one first hole.

2. The photosensing apparatus according to claim 1, wherein each of the at least one first photosensitive elements is disposed at a distinct spatial location behind said reflector.

3. The photosensing apparatus according to claim 1, further comprising at least one light emitting source disposed at a periphery of said reflector unit.

4. The photosensing apparatus according to claim 1, wherein said first hole is at least 0.01 in diameter.

5. The photosensing apparatus according to claim 1, wherein said first hole has a cross-sectional shape selected from the group consisting of diamond, trapezoidal, circular, triangular, oval, composite diamond/rectangular, and rectangular.

6. The photosensing apparatus according to claim 1, further comprising a transparent material disposed within said first hole, said transparent material permitting light to pass therethrough.

7. The photosensing apparatus according to claim 1, further comprising a second hole, said first photosensitive element disposed behind said reflector for simultaneously receiving light passing through said first hole and said second hole.

8. The photosensing apparatus according to claim 1, further comprising a second hole and a second photosensitive element, said second photosensitive element disposed behind said reflector for receiving light passing through said second hole, the first hole and the second hole being disposed along a center line substantially extending in the middle of said reflector unit.

9. A display photosensing system for precision sensing of emitted light, comprising:
a reflector means configured to have at least one light exiting means; and
at least one photodetecting means disposed behind said reflector means for receiving a light passing through said at least one light exiting means.

10. The photosensing system according to claim 9 wherein each of the at least one photodetecting means is disposed at a distinct spatial location behind said reflector means.

11. The photosensing system according to claim 9, further comprising at least one light emitting means disposed at the periphery of said reflector means.

12. The photosensing system according to claim 9, wherein said light exiting means is at least 0.01 mm in diameter.

13. The photosensing system according to claim 9, wherein each of said at least one light exiting means has a cross-sectional shape selected from the group consisting of diamond, trapezoidal, circular, triangular, oval, composite diamond/rectangular, and rectangular.

14. The photosensing system according to claim 9, further comprising a transparent material disposed within said light exit means, said transparent material permitting the light to pass therethrough.

15. The photosensing system according to claim 9, further comprising a second light exiting means, wherein said first photodetecting means disposed behind said reflector means simultaneously receives the light passing through said first light exiting means and said second light exiting means.

16. The photosensing system according to claim 9, further comprising a second light exiting means and a second photodetecting means, said second photodetecting means being disposed behind said reflector means for receiving the light passing through said second exiting means, and the first exiting means and the second exiting means being disposed along a center line substantially extending in the middle of said reflector means.
